(19) United States
(12) Patent Application Publication
(10) Pub. No.: US 2006/0031440 A1
(43) Pub. Date: Feb. 9, 2006

(54) Usage data harvesting

(75) Inventor: Alexis S R Ashley, Kedhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/534,808

(22) PCT Filed: Nov. 5, 2003
(86) PCT No.: PCT/IB03/05037

§ 371 Date: May 12, 2005

(30) Foreign Application Priority Data
Nov. 15, 2002 (GB) 0226648.4

(51) Int. Cl. G06F 15/173

(52) U.S. Cl. 709/223

(57) ABSTRACT

A method of harvesting usage data from a broadcast receiver configured to detect and store such usage data comprises providing (16, 18) to the receiver a privacy policy identifying not only the usage data sought to be harvested but also the intended use for such data. At the receiver, an interactive or automated determination (22) is made as to whether a received privacy policy is acceptable; and if so, the receiver selects (30) from store the usage data identified in the privacy policy and transmits (28) the same to the sender of the privacy policy. A receiver apparatus configured to support the method is also provided.

The present invention relates to methods for collection of data relating to selections made by a user and to apparatuses supporting the same. In particular, although not exclusively, the invention relates to the gathering of usage data for broadcast television receivers.

It is possible for a set top box (or any other broadcast television receiver) to record the actions of the consumer, such as which channels they watch and when they watch them. When this set top box is connected to a return channel, this information could be transferred from the set top box to another party.

This information is useful to companies such as broadcasters for analysing viewing demographics, and for targeting consumers with offers and services that might be of interest to them. For the consumer, however, there are privacy issues with the use of their viewing habit information and this can lead to a reluctance on the part of users to make their information available.

It is an object of the present invention to at least partially address the above mentioned issue.

In accordance with a first aspect of the present invention there is provided a method of harvesting usage data from a broadcast receiver configured to detect and store such usage data, comprising:

providing to said receiver a privacy policy identifying the usage data sought to be harvested and the intended use for such data;

at said receiver determining whether a received privacy policy is acceptable; and

if acceptable, at the receiver selecting from store the usage data identified in the privacy policy and transmitting the same to the sender of the privacy policy.

By delivering a privacy policy specifying the use the data is to be put to, the user is better able (and more likely) to opt for acceptance. At the same time, the policy provides a specification to the receiver as to which harvested data (which may be only a small subset of the data gathered by the receiver) is to be transmitted.

The receiver may present a received privacy policy to a user, with acceptance or otherwise of said policy being determined by user input: in such a case, the receiver may format the received privacy policy prior to presentation to the user, for example to present simple lists of the information required or the intended use(s) to make it more readily understandable by the user. Alternatively, the receiver may store privacy policy preference data for a user and, based on the same, determine automatically whether a received privacy policy is acceptable. With such a pre-stored preference profile, the user is not required to interact each time a data gathering request (in the form of a privacy policy) is received.

As the user may not be satisfied with the basic information carried by the privacy policy, the step of determining acceptance may include a process of negotiation between the receiver user and the sender of the privacy policy, for example to enable the user to find out more about the intended use and/or destination of the data.

A received privacy policy may be partly accepted, with only a part of the requested usage data being transmitted as a result. For example, a user may be willing to share data about receiver usage (such as which programmes are watched or recorded) but unwilling to share personal data such as name, age or gender. To counter such worries, the receiver may remove direct identifiers for the user from the usage data prior to transmitting to the sender of the privacy policy. Such removal may comprise simple deletion or replacement by a pseudonym or other dummy data.

In one example use of the present invention, the sender of the privacy policy provides conditional access broadcast services and access thereto is conditional on user acceptance of the privacy policy and transmission of the usage data. By providing such an incentive, users may be encouraged to make their data available.

Also in accordance with the present invention there is provided an apparatus for harvesting of usage data comprising:

a broadcast receiver (which may be a broadcast television receiver);

monitoring and storage means coupled with said broadcast receiver and arranged to detect and store usage data relating to a users operation of said receiver;

an input to receive a privacy policy identifying usage data sought to be harvested and the intended use for such data;

control means coupled with said input and said storage means and operable to determine whether a received privacy policy is acceptable; and

an output connectable to a back channel to the source of the privacy policy,

the control means being arranged, on determination that said received privacy policy is acceptable, to select from said storage means the usage data identified in the privacy policy and transmit the same to the output.

These and other aspects of the present invention are recited in the appended claims which are incorporated herein by reference and to which the reader is now referred, and/or are described in the following description of embodiments of the invention.

Embodiments of the present invention will now be described by way of example only with reference to the accompanying drawings in which:

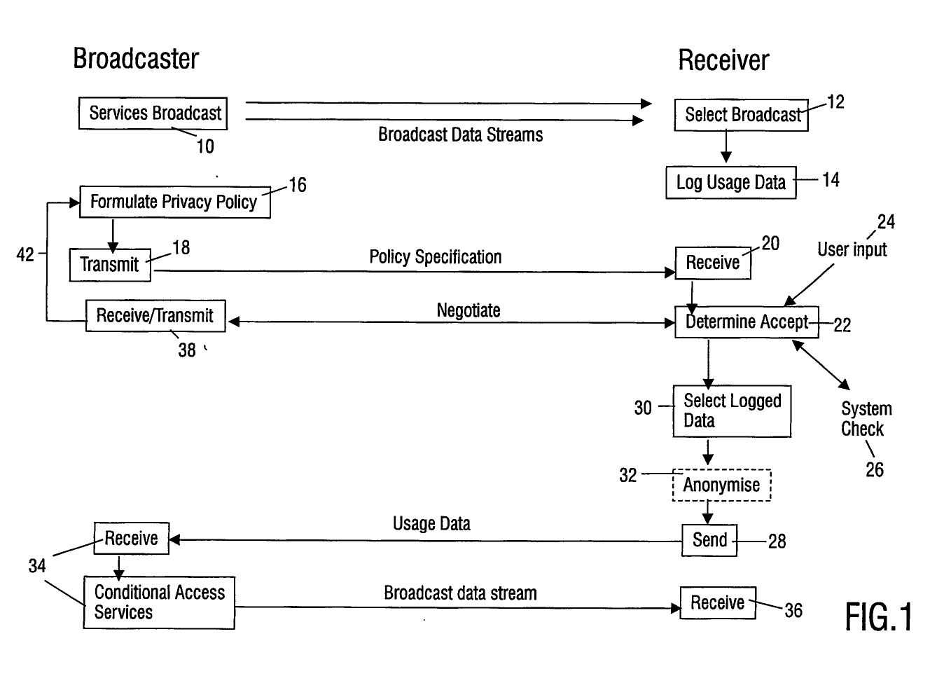

FIG. 1 schematically represents a series of interactions between a broadcaster and a receiver embodying the present invention;

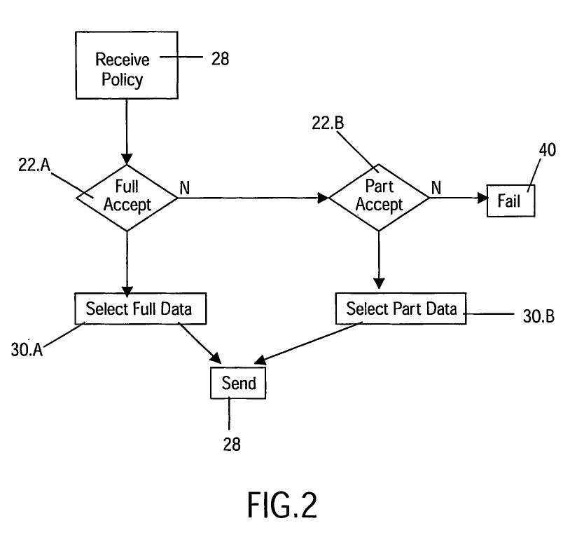

FIG. 2 is a flow chart illustrating alternative steps that may be carried out at the receiver side in FIG. 1; and

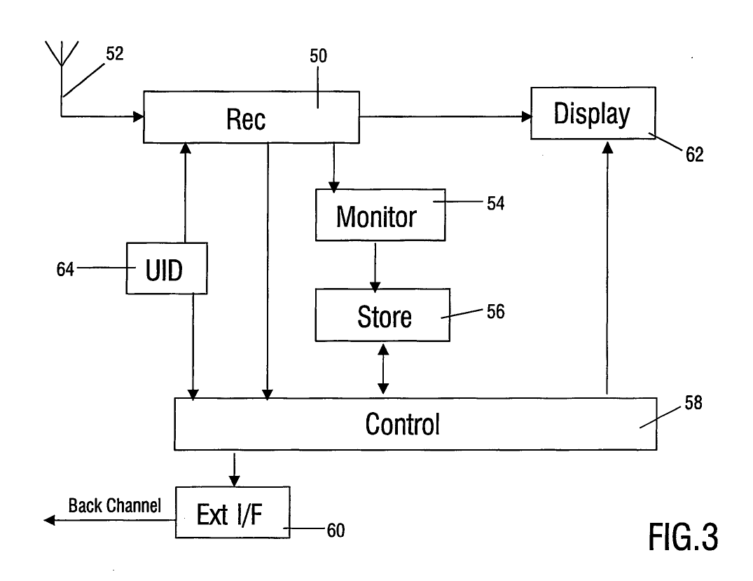

FIG. 3 schematically represents functional features of an apparatus embodying the present invention.

Within this description, the term broadcaster will be used generally to indicate a company or other body that desires to obtain viewer profile information. The will be many different types of company who may desire profiling information, but a broadcaster is a likely first user, and using the term broadcaster helps to clarify the following.

Referring initially to FIG. 1, a series of interactions between a broadcaster (to the left of the Figure) and a receiver (to the right) are illustrated. Initially, the broadcaster transmits 10 one or more broadcast data streams. At the receiver, a selection 12 is made, typically in response to user input, as to which stream (e.g. which television channel) is watched or recorded. Within the receiver, a record 14 is made of such selections in non-volatile storage to build up a picture of the users viewing habits, which information is of interest to the broadcaster to enable improved scheduling of programmes, targeting of special offers and so forth.

Before the broadcaster can receive viewer usage information, they have to create 16 a privacy policy file. The privacy policy file describes all the items of information that the broadcaster wishes to receive, and the intended use for this information. In the following example, the W3C standard P3P (Platform for Privacy Preferences) is used, as described at http://www.w3.org/TR/P3P, but other representations would be equally applicable.

<POLICIES xmlns=“http://www.w3.org/2002/01/P3Pv1”>
<POLICY name=“sample”

discuri=“http://www.example.com/viewing-policy.html”
opturi=“http://www.example.com/opt.html”>
<ENTITY>

<DATA-GROUP>

<DATA ref=“#business.name”>Example, Corp.</DATA>
<DATA ref=“#business.contact-

info.online.email“>privacy@example.com</DATA>

</DATA-GROUP>

</ENTITY>
<ACCESS><none/></ACCESS>
<DISPUTES-GROUP>

<DISPUTES resolution-type=“service”

service=“http://www.example.com/privacy.html”
short-description=“Please contact our customer service desk

with privacy concerns by emailing
privacy@example.com”/>

</DISPUTES-GROUP>
<STATEMENT>

<PURPOSE><admin/><pseudo-analysis/></PURPOSE>
<RECIPIENT><ours/></RECIPIENT>
<RETENTION><indefinitely/></RETENTION>
<DATA-GROUP>

<DATA ref=“#user.gender”>

<CATEGORIES><demographic/></
CATEGORIES>

</DATA>
<DATA ref=“#user.name.family”>

<CATEGORIES><demographic/></
CATEGORIES>

</DATA>
<DATA ref=“#user.name.given”>

<CATEGORIES><demographic/></
CATEGORIES>

</DATA>

<DATA ref=“#dynamic.interactionrecord”>
<CATEGORIES><interactive/><navigation/></
CATEGORIES>
</DATA>
</DATA-GROUP>
<DATA-GROUP base=“http://www.tv-anytime.org/
usage-history-p3p-

schema”>

<DATA ref=“#av.playrecording”/>
<DATA ref=“#av.playstream”/>
<DATA ref=“#av.record”/>
<DATA ref=“#video.slowmotion”/>
<DATA ref=“#data.archive”/>

</DATA-GROUP>

</STATEMENT>

</POLICY>

</POLICIES>

Whilst a detailed discussion of the above example is not necessary, some of the parts will now be identified for the purposes of illustration.

DATA ref=These references identify the data sought, such as user name and gender, times and dates for watching taped audio/video (AV) content or for watching or taping live AV content.

DISPUTES resolution-type=Specifies a mechanism for negotiating or otherwise seeking data about the privacy policy/data harvesting request. In the above example, this is in the form of an e-mail address for a customer service desk.

RECIPIENT

Who will receive the data.

RETENTION

How long the data will be held by the recipient (indefinitely in the above example).

CATEGORIES

Identifies the intended use for the data (for demographic profiling in this example).

Once this policy file has been created, it needs to be transferred 18 to the consumer's set top box. The exact details of this transfer are outside of the scope of this invention, but the skilled reader will be aware of suitable mechanisms for transferring data (in conjunction with the broadcast data or separately) to the receiver.

Once received 20 by the consumer's receiver device, the next step 22 is determining whether or not the stated requested data and its intended uses are acceptable to the user. In an interactive mode, the privacy policy could be displayed to the user (suitable reformatted in some easier to understand form that raw XML), with user input 24 indicating acceptance or otherwise. Alternatively, in a system check 26 a software agent or routine on the device can make a decision on the policy file based on previous configuration (stored privacy policy preference data) by the consumer. The determination may include a negotiation or explanation step with the user contacting the broadcaster 38, for example to seek further information about the intended use and/or destination of the user data. As indicated by arrow 42, this process may conceivably result in the broadcaster reviewing or amending the privacy policy.

When the viewing history is transferred 28 from the consumer to the broadcaster, the policy file is used to filter 30 the viewing history. For example if the policy file indicated that only information about what programmes had been watched was required, all other information in the viewing history would be removed before transfer.

If the purpose of the viewing history is for anonymous profiling (the purpose is specified in the policy file) the set top box can replace 32 any user-identifiable information (such as name, user id, etc) with pseudonyms to ensure that the broadcaster cannot use the viewing history for direct viewer analysis.

If a consumer is going to allow their viewing history to be distributed, they will almost certainly be getting some benefits in return. When the consumer subscribes to this beneficial service, the broadcaster could transmit their privacy policy file to the consumer. Ancillary information would need to be carried along with the privacy file to indicate if acceptance of this policy was a pre-requisite of using their service, or merely optional. As indicated generally at 34 and 36, on receipt of usage data, the broadcaster may make available a benefit such as access to conditional access services, such as subscriber broadcast channels.

FIG. 2 illustrates a variation in the process followed by the receiver in FIG. 1. Following receipt of the privacy policy at 28, a first acceptance test 22.A (which may be interactive or automated as described above) is performed. This test looks for acceptance of all the specifications (data types, intended use, retention time and so forth) identified in the privacy policy. If the test is met, then all the required data is selected 30.A from that held by the receiver and sent 28 to the broadcaster. If the test 22.A fails however, a second test 22.B is made for partial acceptance, for example to determine if the user is willing to submit some of the requested data (which may still have value for the broadcaster). If the second test 22.B fails, the process stops 40 and no data is sent to the broadcaster. If the second test is successful, however, the selection 30.B from the stored data comprises just that data that the user is prepared to submit, which data is then sent 28 as before.

FIG. 3 schematically represents functional features of an apparatus suitable to embody the present invention and support the above described method for harvesting of usage data. The basic requirements of the apparatus are that it is capable of receiving broadcast data (broadcast television signals in this example), that it includes persistent storage of usage history, and that it is connectable to a return channel (for example via modem or broadband internet connection) for delivery of the usage data to the broadcaster or other source of the privacy policy.

In the apparatus of FIG. 3, a broadcast receiver 50 has an input 52 to receive broadcast television signals. This input 52 may be an aerial as shown, or it may for example comprise a satellite dish or connection to a terrestrial cable television network. A monitoring stage 54 with associated non-volatile storage (for example a local hard disk drive) 56 is coupled with the receiver 50. In use, the monitor stage 54 detects the viewing information in terms of what channel and programme is being watched, and saves this usage data in store 56. The apparatus has an input to receive the privacy policy: in the example shown, the privacy policy is delivered by the same means as the broadcast data, and so input 52 is used. Where an alternative delivery mechanism is used for the privacy policy, a separate input (not shown) may be provided.

A control stage 58 (which may suitably be provided by a microcontroller or other processor device) is coupled with the input 52 for the privacy policy (via the receiver 50 in this instance). The control stage 58 is also connected to the store 56 and operates to determine whether a received privacy policy is acceptable and, if so, to select from the store 56 the usage data identified in the privacy policy. An external interface 60 coupled with the control stage 58 provides an output connectable to a back channel to the source of the privacy policy.

An output device 62 in the form of a display (which may be integral with the receiver apparatus or coupled externally) permits the control stage 58 to present a received privacy policy to a user, suitably following reformatting to make it easier for an unskilled user to comprehend. A user input device 64 provides a means by operation of which a user determines acceptance or otherwise of the policy in an interactive acceptance test as described previously. For the automated acceptance test, the store 56 holds the privacy policy preference data for a user and, based on the same, the control stage 58 determines automatically whether a received privacy policy is acceptable.

In the foregoing we have described a method of harvesting usage data from a broadcast receiver configured to detect and store such usage data comprises providing to the receiver a privacy policy identifying not only the usage data sought to be harvested but also the intended use for such data. At the receiver, an interactive or automated determination is made as to whether a received privacy policy is acceptable; and if so, the receiver selects from store the usage data identified in the privacy policy and transmits the same to the sender of the privacy policy. A receiver apparatus configured to support the method is also provided.

From reading the present disclosure, other modifications will be apparent to persons skilled in the art. Such modifications may involve other features which are already know in the field of data harvesting, methods and apparatuses supporting the same, and applications thereof, and which may be used instead of or in addition to features already described herein.

1. A method of harvesting usage data from a broadcast receiver configured to detect and store such usage data, comprising:
providing (16, 18) to said receiver a privacy policy identifying the usage data sought to be harvested and the intended use for such data;
at said receiver determining (22) whether a received privacy policy is acceptable; and
if acceptable, at the receiver selecting (30) from store the usage data identified in the privacy policy and transmitting (28) the same to the sender of the privacy policy.

2. A method as claimed in claim 1, wherein the receiver presents a received (20) privacy policy to a user, and acceptance or otherwise of said policy is determined by user input (24).

3. A method as claimed in claim 2, wherein the receiver formats the received privacy policy prior to presentation to the user.

4. A method as claimed in claim 1, wherein the receiver stores privacy policy preference data for a user and, based (26) on the same, determines (22) automatically whether a received privacy policy is acceptable.

5. A method as claimed in claim 1, wherein the step of determining acceptance (22) includes a process of negotiation (38) between the receiver user and the sender of the privacy policy.

6. A method as claimed in claim 1, wherein a received privacy policy may be partly accepted (22.B), with only a part (30.B) of the requested usage data being transmitted (28) as a result.

7. A method as claimed in any of claims 1 to 6, wherein the receiver removes (32) direct identifiers for the user from the usage data prior to transmitting (28) to the sender of the privacy policy.

8. A method as claimed in any of claims 1 to 7, wherein the sender of the privacy policy provides (34) conditional access broadcast services and access thereto is conditional on user acceptance of the privacy policy and transmission of the usage data.

9. Apparatus for harvesting of usage data comprising:
a broadcast receiver (50);
monitoring (54) and storage (56) means coupled with said broadcast receiver (50) and arranged to detect and store usage data relating to a users operation of said receiver;
an input (52) to receive a privacy policy identifying usage data sought to be harvested and the intended use for such data;
control means (58) coupled with said input (52) and said storage means (56) and operable to determine whether a received privacy policy is acceptable; and
an output (60) connectable to a back channel to the source of the privacy policy,
the control means (58) being arranged, on determination that said received privacy policy is acceptable, to select from said storage means (56) the usage data identified in the privacy policy and transmit the same to the output.

10. Apparatus as claimed in claim 9, further comprising an output device (62) wherein the control means (58) presents a received privacy policy to a user, and user input means (64) by operation of which a user determines acceptance or otherwise of said policy.

11. A method as claimed in claim 10, wherein the control means (58) is arranged to format the received privacy policy prior to presentation by the output device (62).

12. Apparatus as claimed in claim 9, wherein the storage means (56) holds privacy policy preference data for a user and, based on the same, the control means (58) determines automatically whether a received privacy policy is acceptable.

13. Apparatus as claimed in claim 9, wherein the control means (58) is further operable to determine partial acceptance of a received privacy policy, and to select from said storage means (56) only a part of the requested usage data.

14. Apparatus as claimed in any of claims 9 to 13, wherein the control means (58) is arranged to remove direct identifiers for the user from the usage data prior to outputting.

15. Apparatus as claimed in any of claims 9 to 14, wherein the broadcast receiver (50) is a broadcast television receiver.
